(19) United States
(12) Patent Application Publication
(10) Pub. No.: US 2024/0319973 A1
(43) Pub. Date: Sep. 26, 2024

(54) AUTOMATED INFRASTRUCTURE PROVISIONING OF CONTAINERIZED APPLICATIONS

(71) Applicant: Royal Bank of Canada, Toronto (CA)

(72) Inventors: Gopi Krishna Balasingam, Markham (CA); Richard Ronald Langlois, Amherstview (CA); Amandeep Singh Barbra, Toronto (CA)

(21) Appl. No.: 18/597,355

(22) Filed: Mar. 6, 2024

Related U.S. Application Data
(60) Provisional application No. 63/451,328, filed on Mar. 10, 2023.

(51) Int. Cl. G06F 8/41; G06F 8/36; G06F 8/60; G06F 8/75

(52) U.S. Cl. CPC G06F 8/41; G06F 8/36; G06F 8/60; G06F 8/75

(57) ABSTRACT

A method for developing a containerized application using an opinionated pipeline and subsequent deployment of the containerized application to a cloud environment, the method comprising the steps of: receiving an application containing original code; generating a variable file based on parameters selected by a developer of the application; using the parameters to select a plurality of application development processes and tools from a set of available tools and processes; dynamically provisioning the opinionated pipeline to include the plurality of application development processes and tools; implementing the opinionated pipeline in order to develop the containerized application by combining a set of code with the original code, the set of code associated with the plurality of application development processes and tools; modifying the set of code based on selections made by the developer to provide modified code; packaging the containerized application to include at least a portion of the original code and the modified code as the application content. Further options include selecting one or more binders based on the parameters; and deploying the containerized application to the cloud environment by applying the one or more binders to the containerized application.

### TECHNICAL FIELD

The present disclosure is directed at development of containerized applications in cloud based environments.

### BACKGROUND

Increasingly, network applications and services are deployed on “cloud” infrastructures. In many cloud infrastructures, a third-party “cloud provider” owns a large pool of physical hardware resources (e.g., networked servers, storage facilities, computational clusters, etc.) and leases those hardware resources to users for deploying network applications and/or services.

Startup companies and other ventures are focused on building and growing their businesses and therefore may not have adequate time and resources to dedicate to adapting their software applications to a new platform, e.g. as utilized by an acquirer institution of the startup company. As such, startup companies don't always have the time or resources to manage their own infrastructure. Therefore it is a need for acquired companies (or otherwise developed collaborative relationships between the startup and institution) to be brought up to the security standards (e.g. network security standards/protocols ) of the institution in a straightforward and efficient manner. It is recognised that cloud-based deployments of network applications and services can be used to address these discussed needs and related challenges.

For example, challenges typically encountered by product development teams can include: difficulties in completing development tasks, i.e. Cloud Exception Process (CEP); excessive development time/effort spent on “Process Overhead” i.e. self-attestation; and/or overly constrained access to the environment and infrastructure of the institution. All or any of these alone, can undesirably impede the desired development speed, effort, and/or timing in the development and deployment of network applications and services.

In terms of deploying and implementing software applications, cloud infrastructures can facilitate many benefits both for the software administrators and for the hardware owners (i.e., cloud providers). Software administrators can specify and lease computing resources (i.e., virtual machines) matching their exact specifications without up-front hardware purchase costs. The administrators can also modify their leased resources as application requirements and/or demand changes. Hardware owners (i.e., cloud providers) also realize substantial benefits from cloud infrastructures. The provider can maximize hardware utilization rates by hosting multiple virtual machines on a single physical machine without fear that the applications executing on the different machines may interfere with one another. Furthermore, the ability to easily migrate virtual machines between physical machines decreases the cloud provider's hardware maintenance costs. For these reasons, even large companies that own substantial hardware resources (e.g. search engine companies, social networking companies, e-commerce companies, etc.) can often deploy those hardware resources as private clouds.

However, we have noted that as the demand for cloud computing has grown, so has the number of cloud computing providers. Different cloud providers often offer varying qualities/levels of service, different pricing, and/or other distinctive features that make those particular providers more desirable for one purpose or another. Accordingly, some organizations, choose to lease resources from multiple cloud providers. Unfortunately, one consequence of using multiple cloud providers is that the interfaces to different providers often differ. Further, managing multiple deployments on multiple clouds has become very problematic for many organizations.

Current application development teams have access to numerous third-party DevOps tools that together facilitates the automation of code integration and deployment. While these DevOps tools and resulting pipelines can provide improved delivery rates, current development teams still face numerous development challenges, such as by example; required access, understanding, management, and/or maintenance of multiple complex and disparate systems. While current development tools can automate many foundational technical aspects of the software development lifecycle, current development teams are still required to undesirably perform a significant number of manual steps in order to adhere to specified requirements pertaining to organizational business processes and controls (e.g. security). Further, current development frameworks only provide for quality and security testing into later stages. As well, individual teams typically encounter redundant audit and compliance work requirements, which can also detract from the desired speed and complexity of application/service development and deployment efforts.

As such, it is recognized that new technology platforms can be introduced frequently to help with changing development team needs, however upskilling and resources required for each development team to build and deploy their applications and meet the standards and controls required for each platform still continues to be overly significant. As such, upskilling required in today's DevOps customization environments can be problematic due to the lack of by standardization of the enablement process(es) relevant to platforms, technologies, and practices. Further, it is recognized that new controls requires time investment from teams to adapt them, which undesirably tends to increase the lead time to deliver the products to market. Further, it is clear that changes to onboarding processes are needed to automate the repetitive manual steps in current DevOps environments.

### SUMMARY

It is an object of the present invention to provide a system and method for infrastructure provisioning of a containerized application that obviates or mitigates at least one of the above presented disadvantages.

A first aspect provided is a method for developing a containerized application using an opinionated pipeline to facilitate subsequent deployment of the containerized application to a cloud environment, the method comprising the steps of: receiving an application containing original code; generating a variable file based on parameters selected by a developer of the application; using the parameters to select a plurality of application development processes and tools from a set of available tools and processes; dynamically provisioning the opinionated pipeline to include the plurality of application development processes and tools; implementing the opinionated pipeline in order to develop the containerized application by combining a set of code with the original code, the set of code associated with the plurality of application development processes and tools; modifying the set of code based on selections made by the developer to provide modified code; packaging the containerized application to include at least a portion of the original code and the modified code as the application content.

Further aspects include selecting one or more binders based on the parameters; and deploying the containerized application to the cloud environment by applying the one or more binders to the containerized application.

A second aspect provided is a system for developing a containerized application using an opinionated pipeline to facilitate subsequent deployment of the containerized application to a cloud environment, the system comprising: one or more computer processors in communication with a memory storing a set of executable instructions for execution by the computer processor to: receive an application containing original code; generate a variable file based on parameters selected by a developer of the application; use the parameters to select a plurality of application development processes and tools from a set of available tools and processes; dynamically provision the opinionated pipeline to include the plurality of application development processes and tools; implement the opinionated pipeline in order to develop the containerized application by combining a set of code with the original code, the set of code associated with the plurality of application development processes and tools; modify the set of code based on selections made by the developer to provide modified code; package the containerized application to include at least a portion of the original code and the modified code as the application content.

Further system aspects include to select one or more binders based on the parameters; and to deploy the containerized application to the cloud environment by applying the one or more binders to the containerized application.

### BRIEF DESCRIPTION OF THE DRAWINGS

In the accompanying drawings, which illustrate one or more example embodiments:

FIG. 1 depicts an example system for automatically developing and deploying containerized applications;

FIG. 2 represents an example workflow for development of containerized applications using the system of FIG. 1;

FIG. 3 shows an example operation of the system of FIG. 1;

FIG. 4 represents an example model of the system of FIG. 1;

FIG. 5 depicts an example orchestration sequence for binders of the system of FIG. 1;

FIG. 6 shows a further example embodiment of the system of FIG. 1; and

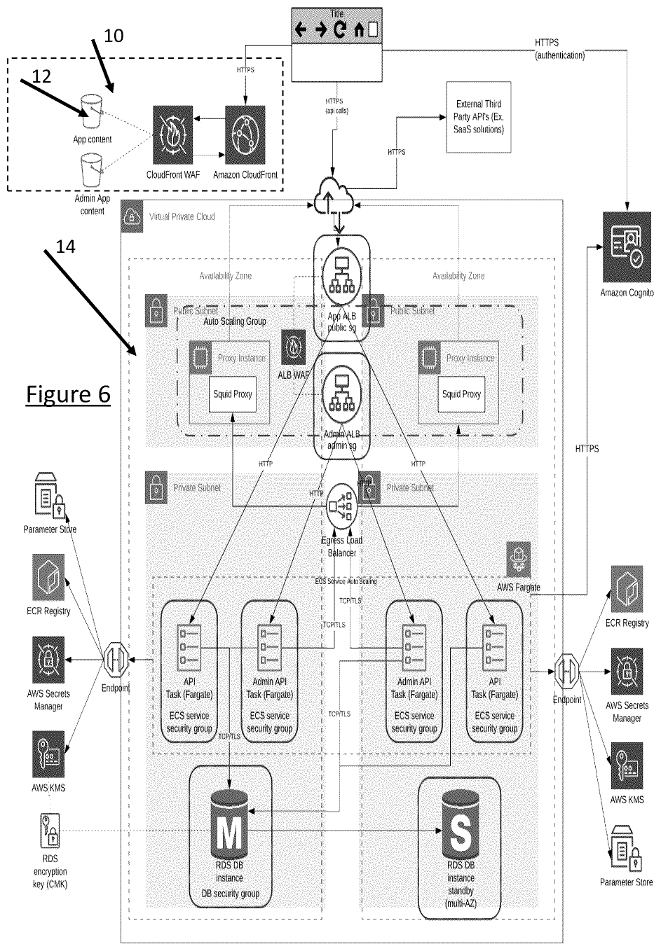

FIG. 7 depicts an example computer system that may be used to implement computer components of the system of FIG. 1.

### THE DETAILED DESCRIPTION

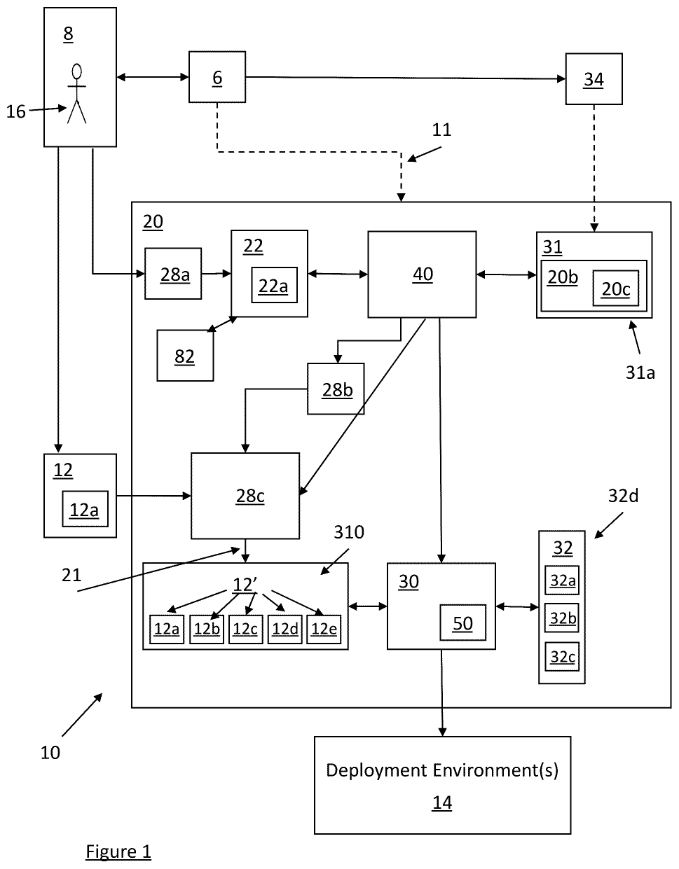

Referring to FIG. 1, shown is an application development and deployment system 10 for developing and deploying a containerized application 12′, as a version of an original application 12 (containing application code 12a) provided by a developer 16 to the system 10. It is recognised that the system 10 can supply a number of advantages to developers 16 of an acquired/collaborative company 8 working with an institution 6 (e.g. owner/provider 11 of a platform 20). As such, these advantages can include such as but not limited to: 1) provide the developers 16 with secure and approved cloud deployment patterns 20b (e.g. a set of automated application development processes and tools 20b selected from a set 31 of available tools and processes); 2) continued support for many of the common cloud deployment patterns 20b out of the box (e.g. stored in storage 31a); 3) facilitate developers 16 to quickly and easily deploy infrastructure (associated with deployment of the containerized application 12′ in a cloud environment 14) and application 12 changes via an included pipeline 21 (e.g. CICD pipeline); and 4) the pipeline 21 is configured as customizable but opinionated, thereby facilitating developers 16 to self-manage infrastructure development of the application 12 (to result in the containerized application 12′) in a controlled manner using the cloud deployment patterns 20b of the platform 20.

It is envisioned that the cloud deployment patterns 20b can be embodied as a collection of infrastructure as reusable code modules (also referred to as the cloud deployment patterns or templates 20b) that have been packaged in a consumable fashion and are deployed via the automation pipeline 21 by the development teams 16 when using the platform 20. The cloud deployment patterns 20b can be advantageously used by the system 10 to enforce cloud security standards (e.g. policy content 34) of the institution 6, as required/specified by the institution as part of the dictated/desired content of the containerized application 12′. As such, the implementation of the pipeline 21 is considered advantageously customizable (via a user supplied definition of a variable file 22) but also opinionated (via the designation/incorporation of code content of the cloud deployment patterns 20b into the content of the resultant containerized application 12′).

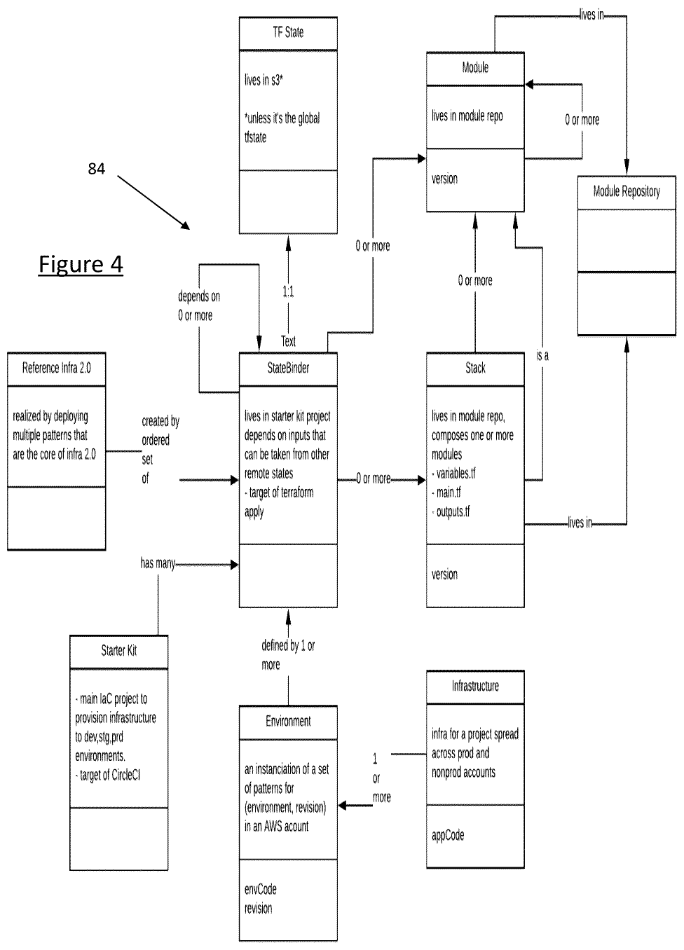

Further, as shown in FIG. 1, the pipeline 21 of the platform 20 is operated by a pipeline/orchestration engine 40, as further described below. Further, as shown in FIGS. 1 and 4, a deployment engine 50 (e.g. as part of a control plane 30) deploys the containerized application 12′ (the result of applying the cloud deployment patterns 20b) using one or more binders 32a,b,c selected from a binder library 32. It is also recognised that each of the respective binders 32a,b,c can be referred to as reusable binders 32a,b,c, such that the particular binder(s) 32a,b,c selected for the binder library 32 is dependent upon the variables 22a defined in the file 22 and in particular one or more of the applied cloud deployment patterns 20b. FIG. 4 shows an example domain model 84 of modules, stacks, and state binder infrastructure, as implemented by the engines 40, 50 as further discussed below.

Referring again to FIG. 1, shown is one embodiment of the application development and deployment system 10 for developing and deploying the containerized application 12′ (e.g. including at least some portions of the original code 12a and at least some portions of the selected cloud deployment patterns 20b) to a cloud environment 14, based on the initially supplied application 12 from the developers 16. One advantage of the system 10 is that it provides the platform 20 where application development teams 16 can deploy their application 12 to one or more cloud environments 14, using a provided opinionated pipeline 21. The platform 20 of the system 10 can facilitate cloud 14 portability for the containerized applications 12′. The system 10 can effectively, post development, host and manage applications 12 in the infrastructure via the control plane 30, for example by abstracting hardware differences between for one or more environments 14 such as but not limited to Azure, AWS, Openshift, VMWare, Mainframe and Pivotal Cloud Foundry deploy applications, in a consistent form factor and manner (e.g. for delivering containerized software applications 12′ for one or more types of mainframe, non-cloud, and cloud environments 14).

As such, as further described below, the platform 20 can be used by the developers 16 to design, codify, document and implement an automated infrastructure pipeline 21 that can be used to build standardized AWS infrastructure (e.g. an example of an environment 14) to result in the containerized application 12′ in a self-serve and safe manner (e.g. via onboarding of the original application 12 with code 12a, and desirably employing a selection of variables 22a using the variables file 22 to coordinate which of the cloud deployment patterns 20b and subsequent binders 32a,b,c are utilized in the development/deployment). This process of using the selected variables 22a facilities the customizable and flexible aspects of the system 10, advantageously.

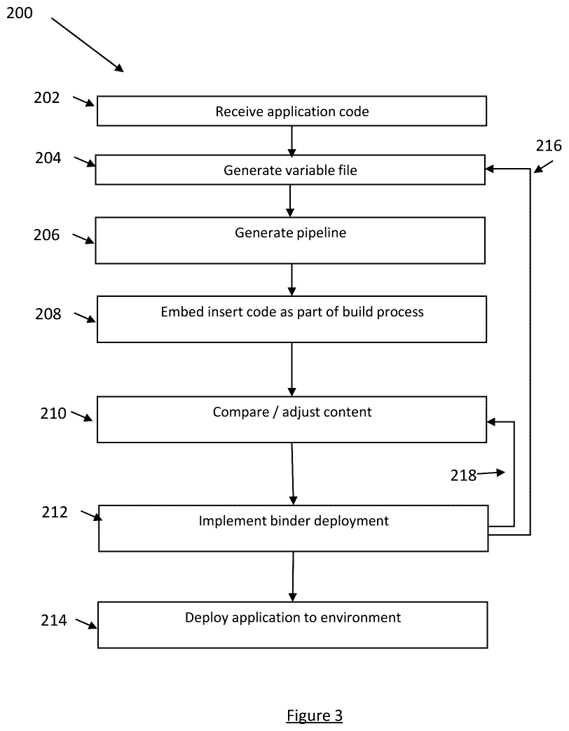

As shown in FIG. 3, as an example only, the variables file 22 can be built by an onboarding process 28a (of the platform 20), in order to select by the developer 16 (via operation of the system 10) which binders 32a,b,c from the binder library 32 (in the storage 32d) and which development processes and tools 20b from the set 31 (in the storage 31a) are used to develop the original application 12 into the deployed application 12′ (in the environment(s) 14). It is recognised that the cloud deployment patterns 20b and binders 32a,b,c can be associated with which of the environment 14 types (e.g. AWS) is selected by the developer 16 during the onboarding process 28a. All of this can be envisioned by appropriate selection/inclusion of the variables 22a in the file 22 (or set of files 22, as desired).

In view of the above, the competitive advantage of the proposed system 10 (e.g. platform 20 and/or control plane 30), in implementation, can be such as but not limited to: advantageously codify and document the requisite architecture (as provided 11 by the institution 6) in a parameterized fashion using infrastructure as code (e.g. development processes and tools 20b) that is consumable by developers 16 during implementation 28c of the pipeline 21; and advantageously provide a consistent control plane 30 across all development teams 16 (and plurality of original applications 12) with ability to rollout incremental improvements to the deployed applications 12′ (and where appropriate the platform 20 such as with modified/new cloud deployment patterns 20b and/or binders 32a,b,c) in a controlled manner.

As further described below, the control plane 30 is the part of the system 10 (e.g. included or separate to the platform 20) that facilitates/controls how applications 12 are deployed to (e.g. Kubernetes) clusters hosted in various cloud environments 14. The control plane 30 can be used to implement associated (e.g. Kubernetes) operators that help to facilitate and govern containerized application 12′ deployments. This control plane 30 can standardize how the system 10 can organize multi-tenancy, facilitate centralized logging and security incident and event management, access secrets, and manage identity and authentication of the applications 12′. The control plane 30 can enforce these standards via infrastructure as code, e.g. embodied as one or more binders 32a, 32b, 32c selected from a binder library 32. The use of the code can also facilitate that critical containerized applications 12′ are deployed in a manner that is consistent with organizational requirements. The control plane 30 has access to the binder library 32 used in deployment of the application 12′ to the environment(s) 14.

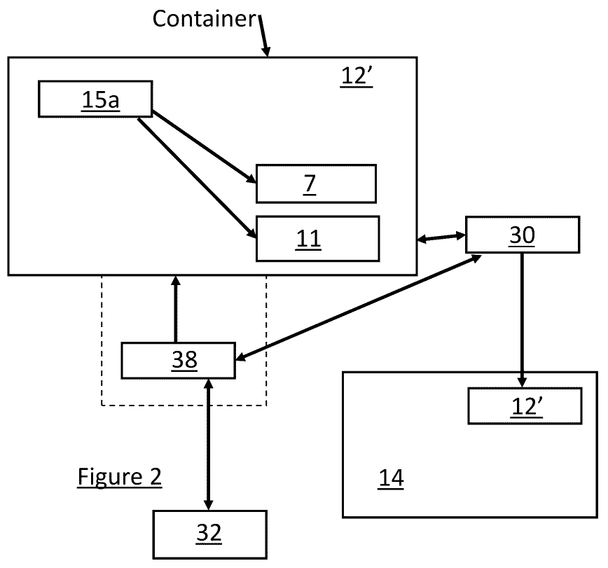

For example, within the Control Plane 30 can be a Git repository 310 (e.g. file storage—see FIG. 1) consisting of a collection of Kubernetes manifests (e.g. files 12a,b,c,d,c) of the various different definitions (e.g. versions) of the applications 12. These manifests/files can be pushed by the control plane 30 from the repository 310 into a local server of the environment 14 to facilitate initial deployment as well as further updates and modifications in the content of the resultant file (e.g. the containerized application 12′). The repository 310 can be monitored by the respective operator service, which can apply (e.g. Kubernetes) resources (using the respective controller) from the repository 310 to a designated (e.g. via environment file 38—see FIG. 2) Kubernetes cluster via the respective designated Kube-API server. As such, the controllers (e.g. Kubernetes controller) associated with their respective operator service can be responsible for continuously monitoring all running applications 12 and comparing their live state to the desired state specified in the Git repository 310.

As discussed above, container applications 12′ provide a standard way to package the application's code 12a, system tools 12b, configurations 12c, runtime 12d, and dependencies 12c (e.g. libraries) into a single object (i.e. container) as part of multiple file system layers 11. A container image as the application 12′ is compiled from file system layers 11 built onto a parent or base image. An application 12′ can be embodied as the container image which is an unchangeable, static file (e.g. image) that includes executable code 12d so the application 12′ can run an isolated process on information technology (IT) infrastructure provided in the respective environment 14. Containers in general can share an operating system OS installed on the server and run as resource-isolated processes, providing reliable, and consistent deployments, regardless of the environment 14. As such, containers encapsulate the application 12′ as the single executable package of software 12′ that bundles application code together with all of the related configuration files, libraries, and dependencies required for it to run. Containerized applications 12′ can be considered “isolated” in that the container application 12′ does not bundle in a copy of the operating system OS (e.g. underlying OS kernel) used to run the application 12′ on a suitable hardware platform in the environment 14. Instead, an open source runtime engine (e.g. Kubernetes runtime engine) is installed on the environment's 14 host operating system and becomes the conduit for container applications 12′ to share the operating system OS with other container applications 12′ on the same computing system of the environment 14.

Referring to FIG. 2, the container application 12′ includes the file system layers 11 including the container configuration 7 (how to run, port, volume details). The file system layers 11 contain all the software components, operating system libraries, of the software-basically all the components 12a,b,c,d,e (see FIG. 1) used to run the software inside the container. A manifest 15a includes information about the image, it's size, the layers and digest. Also associated with the container application 12′ can be binder information 38, in which one or more binders 32 (e.g. 32a,b,c) can be specified for deployment of the container application 12′. As such, the binder file 38 can be used in conjunction with the container application 12′ to instruct the control plane 30 in launching of the container application 12′ in the environments(s) 14 (e.g. how the container application 12′ should be deployed).

For example, a binder-deploy implementation by the control plane 30 (e.g. module as operated by the system 10) can launch the containers application(s) 12′ on a Kubernetes cluster, such that a deploy API can define how Binder templates (e.g. binders 32a,b,c) can be launched on any container management system. For example, in our production platform 20, all templates (e.g. binders 32a,b,c) can be implemented on a Kubernetes cluster using this module.

Referring to FIGS. 1 and 3, shown is an example operation 200 of the platform 20, including: providing 202 the application 12 to the system 10 (e.g. as a copy), recognizing that there can be more than one version and more than one specified environment 14 (e.g. via the file 22); generating 204 the variable file 22 to include selected parameters 22a in order to specify which environment(s) 14 for use in the eventual containerized application 12′, etc., recognizing that steps 202, 204 can be part of the onboarding process 28a of the platform 20 as the variables 22a are selected by the development team 16; implementing 206 (also referred to as 28b) the build process of the containerized application 12′ by provisioning the pipeline 21 including using the cloud deployment patterns 20b and subsequent binders 32a,b,c as specified/dictated by the variables 22a in the file 22; generate 208 the containerized application 12′ incorporating the portions of the cloud deployment patterns 20b and the original code 12a; compare 210 the content of the containerized application 12′ against one or more policies 39 (e.g. security policies) of the institution 6 (e.g. also referred to as a static code analysis).

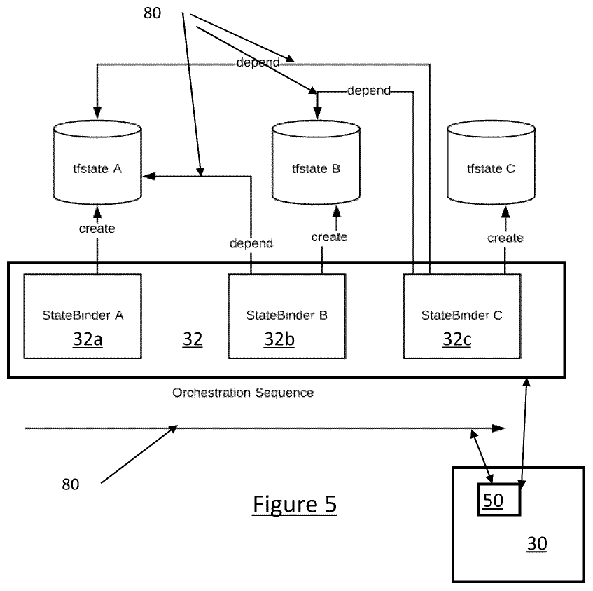

Given the above, if the static code analysis is passed, then the container application 12′ content can be then passed to the control plane 30 in order to implement 212 the binder 32a,b,c deployment, shown by example in FIG. 5. Once the step 212 is complete, the containerized application 12′ can be deployed 214 to the environment 14, as originally specified in the variables file 22, including assigned dependencies 82.

As such, the example operation 200 can provide an automated method for developing the containerized application 12′ using the opinionated pipeline 21 and subsequent deployment of the containerized application 12′ to the cloud environment(s) 14. The method can include: receiving the application 12 containing original code 12a; generating a variable file 22 based on parameters 22a selected by a developer 16 of the application 12; using the parameters 22a to select a plurality of application development processes and tools 20b from a set 31 of available tools and processes; dynamically provisioning the opinionated pipeline 21 to include the plurality of application development processes and tools 20b; implementing the opinionated pipeline 21 in order to develop the containerized application 12′ by combining a set of code 20c (see FIG. 1) with the original code 12a, the set of code 20c associated with the plurality of application development processes and tools 20b; modifying the set of code 20c based on selections made by the developer 16 (in interaction with the platform 20) to provide modified code 12b, 12c, 12d, 12e; packaging the containerized application 12′ to include at least a portion of the original code 12a and the modified code 12b, 12c, 12d, 12e; selecting one or more binders 32a,b,c based on the parameters 22a; and deploying the containerized application 12′ to the cloud environment(s) 14 by applying the one or more binders 32a,b,c to the containerized application 12′.

FIG. 5 shows an example of an orchestration sequence 80 for the binders 32a,b,cselected/specified by the content of the variable file 22. It is recognized that advantageously not all binders 32a,b,c resident in the binder library 32 may be needed in order to deploy the containerized application 12′. It is recognized that one or more of the binders 32a,b,c may fail (see FIG. 3) in their application by the control plane 30, thus making a recomparison/adjustment of content 218 by redoing step 210 and/or revising 216 the variables 22a selected in the file 22 (in step 204—see FIG. 3) in order to subsequently rerun the pipeline 21.

FIG. 4 shows an example domain model 84 of modules, stacks, and state binder infrastructure, as implemented by the engines 40, 50 as discussed above. For example, Terraform stores information about the infrastructure of the containerized application 12′ in a state file. This state file can keep track of resources created by the configuration of the containerized application 12′ and maps them to real-world resources of the environment 14. For example, the model 84 can be embodied, by example, as: a 100% cloud-native and runs on Amazon Web Services (AWS); built using Terraform and deployed via CircleCI; security hardened to CIS Benchmarks and institutional Cloud Control Objectives (e.g. examples of policies 34); and utilize built-in IaC linting and static code analysis.

In view of the above, it is recognised that the pipeline 21 can include various stages such as but not limited to: build automation/continuous integration, automation testing, validation, and reporting, as represented by the plurality of application development processes and tools 20b. As such, the pipeline 21 can be referred to as an opinionated pipeline 21, which once provisioned, provides for a continuous integration and continuous deployment (CI/CD) mechanism, as an automated series of steps that are performed in order to deliver a (e.g. new version) of application software application 12 as the containerized application 12′. The pipeline 21 can be dynamically provisioned 28b by the orchestration engine 40, such that the orchestration engine 40 generates 28b a respective pipeline 21 for the original application 12, based on its respective configuration/variables file 22. Further, the engine 40 can be used to operate/implement the pipeline 21.

As described, the file 22 content (e.g. code templates 20b) can be incorporated 28b and can be used in the provisioning of the pipeline 21 (e.g. setup and ordering of appropriate processes and tools 20b for the specified application 12 as defined in an onboarding process 28a). In other words, each pipeline 21 can be advantageously dynamically generated for a particular application 12, based on application parameters 22a (e.g. specified platform, specified security requirements, specified functionality, etc.) provided by the developer 16 during the onboarding process 28a. The variable content 22a can include (e.g. code) content related to application features such as but not limited to program language, user interface configuration, business unit operational/process/feature differences, etc.

For example, as a result of operation of the platform 20, as discussed above, the container applications 12′ can provide a standard way to package the application's code 12a, system tools, configurations, runtime, and dependencies (e.g. libraries) into a single object (i.e. container) as part of multiple file system layers 11. A container image as the application 12 is compiled from file system layers built onto a parent or base image. An application 12 can be embodied as the container image which is an unchangeable, static file (e.g. image) that includes executable code so the container application 12′ can run an isolated process on information technology (IT) infrastructure provided in the respective environment 14. Containers in general can share an operating system OS installed on the environment 14 server and run as resource-isolated processes, providing reliable, and consistent deployments, regardless of the environment. As such, containers encapsulate the application 12 as the single executable package of software that bundles application code together with all of the related configuration files, libraries, and dependencies required for it to run. Containerized applications 12′ can be considered “isolated” in that the container application 12′ does not bundle in a copy of the operating system OS (e.g. underlying OS kernel) used to run the application 12′ on a suitable hardware platform in the environment. Instead, an open source runtime engine (e.g. Kubernetes runtime engine) is installed on the environment's 14 host operating system and becomes the conduit for container applications 12′ to share the operating system OS with other container applications 12′ on the same computing system of the environment. As such, it is recognised that each respective environment 14 can have its own different respective operating system.

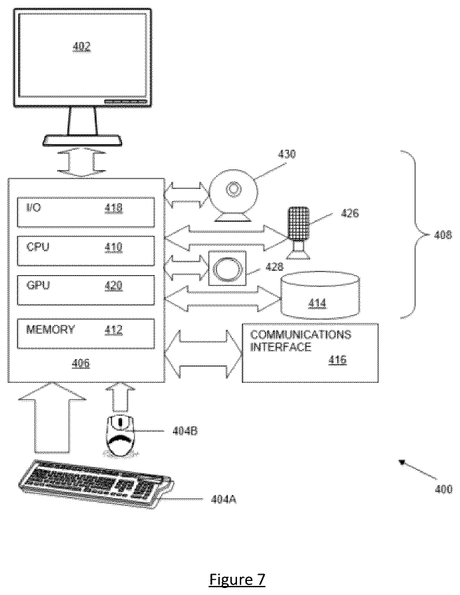

An example computer system in respect of which the technology herein described may be implemented is presented as a block diagram in FIG. 7, for example in implementing engines 40, 50 and/or the platform 20 itself. The example computer system is denoted generally by reference numeral 400 and includes a display 402, input devices (e.g. for specifying/selecting the variables 22a of the file 22) in the form of keyboard 404A and pointing device 404B, computer 406 and external devices 408. While pointing device 404B is depicted as a mouse, it will be appreciated that other types of pointing device, or a touch screen, may also be used.

The computer 406 may contain one or more processors or microprocessors, for example in implementing engines 40, 50 and/or the platform 20 itself, such as a central processing unit (CPU) 410. The CPU 410 performs arithmetic calculations and control functions to execute software stored in a non-transitory internal memory 412, preferably random access memory (RAM) and/or read only memory (ROM), and possibly additional memory 414. The additional memory 414 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 414 may be physically internal to the computer 406, or external as shown in FIG. 7, or both. It is recognised that the memory 412, 414 can be examples of the storages 31a, 32d.

The one or more processors or microprocessors may comprise any suitable processing unit such as an artificial intelligence accelerator, programmable logic controller, a microcontroller (which comprises both a processing unit and a non-transitory computer readable medium), AI accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal and/or additional memory 414 for execution by the one or more processors or microprocessors to effect the development and deployment of the applications 12 on the platform 20, such that each application 12 gets its own pipeline 21 (as generated and managed by the engines 40, 50).

The computer system 400 may also include other similar means for allowing computer programs or other instructions to be loaded. Such means can include, for example, a communications interface 416 which allows software and data to be transferred between the computer system 400 and external systems and networks. Examples of communications interface 416 can include a modem, a network interface such as an Ethernet card, a wireless communication interface, or a serial or parallel communications port. Software and data transferred via communications interface 416 are in the form of signals which can be electronic, acoustic, electromagnetic, optical or other signals capable of being received by communications interface 416. Multiple interfaces, of course, can be provided on a single computer system 400.

Input and output to and from the computer 406 is administered by the input/output (I/O) interface 418. This I/O interface 418 administers control of the display 402, keyboard 404A, external devices 408 and other such components of the computer system 400. The computer 406 also includes a graphical processing unit (GPU) 420. The latter may also be used for computational purposes as an adjunct to, or instead of, the (CPU) 410, for mathematical calculations.

The external devices 408 can include a microphone 426, a speaker 428 and a camera 430. Although shown as external devices, they may alternatively be built in as part of the hardware of the computer system 400 The various components of the computer system 400 are coupled to one another cither directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems such as servers in communication with one another on a computer network. One example is where the network components 20, 30, 40, 50 are in communication with one another on a communications network, such that each of the network components 20, 30, 40, 50 are implemented on a computer system 400.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method for developing a containerized application using an opinionated pipeline to facilitate subsequent deployment of the containerized application to a cloud environment, the method comprising the steps of:
receiving an application containing original code;
generating a variable file based on parameters selected by a developer of the application;
using the parameters to select a plurality of application development processes and tools from a set of available tools and processes;
dynamically provisioning the opinionated pipeline to include the plurality of application development processes and tools;
implementing the opinionated pipeline in order to develop the containerized application by combining a set of code with the original code, the set of code associated with the plurality of application development processes and tools;
modifying the set of code based on selections made by the developer to provide modified code; and
packaging the containerized application to include at least a portion of the original code and the modified code as the application content to result in the containerized application.

2. The method of claim 1 further comprising selecting one or more binders based on the parameters and deploying the containerized application to the cloud environment by applying the one or more binders to the containerized application to result in a deployed version of the containerized application.

3. The method of claim 1 further comprising implementing a comparison of the application content against policy content using static code analysis.

4. The method of claim 3 further comprising modifying content of the variables in the variable file in order to direct customization of the containerized application development.

5. The method of claim 1, wherein the set of code includes code template content selected from the group consisting of: policy content; security content; selected environment content, code option content, and use case content.

6. The method of claim 1 further comprising obtaining the parameters as application parameters as provided an onboarding process.

7. The method of claim 6, wherein content of the application parameters includes code content related to application features selected from the group consisting of; program language, user interface configuration, business unit operational features, business unit process features, and business unit differences.

8. The method of claim 7, wherein the content include at least one of a specified platform, a specified security requirement, and/or a specified functionality for the containerized application.

9. The method of claim 1 further comprising a failure in application of at least one of the one or more binders.

10. The method of claim 3, wherein the policy content is related to security of network communication.

11. A system for developing a containerized application using an opinionated pipeline to facilitate subsequent deployment of the containerized application to a cloud environment, the system comprising:
one or more computer processors in communication with a memory storing a set of executable instructions for execution by the computer processor to:
receive an application containing original code;
generate a variable file based on parameters selected by a developer of the application;
use the parameters to select a plurality of application development processes and tools from a set of available tools and processes;
dynamically provision the opinionated pipeline to include the plurality of application development processes and tools;
implement the opinionated pipeline in order to develop the containerized application by combining a set of code with the original code, the set of code associated with the plurality of application development processes and tools;
modify the set of code based on selections made by the developer to provide modified code; and
package the containerized application to include at least a portion of the original code and the modified code as the application content to result in the containerized application.

12. The system of claim 11 further comprising select one or more binders based on the parameters;
and deploy the containerized application to the cloud environment by applying the one or more binders to the containerized application to result in a deployed version of the containerized application.

13. The system of claim 12 further comprising a control plane for implementing the one or more binders using an orchestration sequence.

14. The system of claim 11 further comprising implementing a comparison of the application content against policy content using static code analysis.

15. The system of claim 14 further comprising modifying content of the variables in the variable file in order to direct customization of the containerized application development.

16. The system of claim 11 further comprising obtaining the parameters as application parameters as provided an onboarding process.

17. The system of claim 16, wherein content of the application parameters includes code content related to application features selected from the group consisting of; program language, user interface configuration, business unit operational features, business unit process features, and business unit differences.

18. The system of claim 17, wherein the content include at least one of a specified platform, a specified security requirement, and/or a specified functionality for the containerized application.

19. The system of claim 11 further comprising a failure in application of at least one of the one or more binders.

20. The system of claim 13, wherein the policy content is related to security of network communication.
